(19) United States
(12) Patent Application Publication
(10) Pub. No.: US 2007/0131077 A1
(43) Pub. Date: Jun. 14, 2007

(54) Wheel holder and chuck assembly

(76) Inventor: Young-Min Kim, Paju-si (KR)

Correspondence Address: KED & ASSOCIATES, LLP, P.O. Box 221200, Chantilly, VA, 20153-1200, US

(21) Appl. No.: 11/604,871

(22) Filed: Nov. 28, 2006

(30) Foreign Application Priority Data
Nov. 29, 2005 (KR) 10-2005-00114791

(51) Int. Cl. B26D 3/08

(52) U.S. Cl. 83/886

(57) ABSTRACT

Provided is a wheel holder and chuck assembly of a scriber for scribing a substrate made of a brittle material, including: a bearing mounted on a head of the scriber for scribing the substrate made of a brittle material; a wheel holder whose one end is connected to a holder shaft, and whose the other end has a wheel attached thereto; and a chuck whose one end is connected to the bearing, and whose the other end is detachably coupled to the holder shaft of the wheel holder. According to the present invention, only the wheel holder, when the wheel 52 is worn, is replaced without additional replacement of the bearing as in the conventional scriber, thus reducing the maintenance cost. Also, the wheel holder is conveniently attached to and detached from the head using the chuck, thus facilitating replacement of the wheel holder.

### BACKGROUND OF THE INVENTION

1. Field of the Invention

The present invention relates to a wheel holder and chuck assembly of a scriber for a brittle substrate, and more particularly to a wheel holder and chuck assembly of a scriber for cutting a substrate made of a brittle material such as glass.

2. Description of the Background Art

Generally, a glass substrate used as a substrate for a display is first fabricated as a large-sized substrate and then cut into a plurality of small individual substrates suited to their applications.

A process of cutting a brittle material such as a glass substrate generally includes scribing a surface of the substrate using a diamond-tipped tool having a hardness larger than the glass substrate to form a cutting line on the substrate, and pressing the substrate about the cutting line formed thereon to cut the substrate along the cutting line.

More specifically, the scribing process is a process of rotating a cutting wheel to form cracks at a cutting position of the substrate. The cutting process is a process of positioning a break bar, formed of a material leaving no scratch mark on the glass substrate, on the cracks and instantaneously applying proper pressure to the break bar so that the cracks propagate in a thickness direction thereof.

An apparatus for scribing a substrate made of a brittle material is generally referred to as a scriber.

FIG. 1 is a schematic view showing a structure of a conventional wheel holder assembly for a scriber.

Referring to FIG. 1, the scriber includes a wheel 16 in rolling contact with a glass substrate 19 to form a cutting line, a wheel holder 15 fixing and supporting the wheel 16, and a head 10 on which the wheel 16 and the wheel holder 15 are adjustably mounted.

In addition, a linear motion (LM) guide 17 is connected to one side of the head 10 to horizontally and vertically move the head 10, and connected to a separate drive apparatus and driven thereby.

As a result, the head 10 moves depending on vertical or horizontal movement of the guide 17.

The head 10 includes a cylinder 18 for applying pressure to the wheel holder 15, a load cell 11 measuring the pressure applied by the cylinder 18, a bar 12 transferring the pressure applied by the cylinder 18 downward through the load cell 11, and a bearing 13 installed at a lower part of the head 10 and coupled with a holder shaft 14 of the wheel holder 15 at the center thereof.

One end of the bar 12 is connected to one part of the head 10, and the other end of the bar 12 is a free end. The bar 12 is disposed between the cylinder 18 and the bearing 13 to transmit the pressure applied by the cylinder 18 to the wheel holder 15 through the bearing 13.

Hereinafter, problems of the conventional scriber will be described in detail with reference to FIG. 2 showing a specific coupling structure of the head 10 and the bearing 13.

FIG. 2 is a schematic view showing the structure of the conventional scriber shown in FIG. 1, which helps explaining problems of the conventional scriber. The scriber of FIG. 2 includes a wheel 25 in rolling contact with a glass substrate to form cracks therein, a wheel holder 24 with which the wheel 25 is rotatably coupled, a holder shaft 23 coupled to one end of the wheel holder 24 at its one end, a bearing 22 coupled to the other end of the holder shaft 23 at its center, a head 20 on which the bearing 22 is mounted, and a bolt 21 fixing an outer periphery of the bearing 22 to the head 20.

The conventional scriber enables the wheel 25 to come into rolling contact with the glass substrate and move along the cutting line on the glass substrate, with varying the position of the head 20, thereby creating cracks on a surface of the glass substrate.

At this point, a change in the scribing direction requires a corresponding change in the direction of the wheel 25, which is performed by rotating the bearing 22 connected to the holder shaft 23.

However, since the wheel holder 24 is connected to the head 20 through the bearing 22, replacement of the worn wheel requires separation of the head 20 from the bearing 22 by unscrewing the bolt 21. Then, a new bearing assembled with a new holder has to be mounted.

A separate tool has to be used to screw or unscrew the bolt 21 when replacing the wheel holder 24 with a new one. Moreover, the bolt 21 may be lost during the replacement.

The replacement of the wheel 25 requires replacement of the bearing 22 which is relatively durable, as well as the wheel holder 24, thereby increasing maintenance cost.

The alignment is also required between a center of an axis of the wheel holder 24, a center of the bearing 22, and a center of the head 20 to determine exact cutting positions of the glass substrate, whenever replacing the worn wheel with a new one.

### BRIEF DESCRIPTION OF THE INVENTION

In order to solve the above problems, an object of the present invention is to provide a wheel holder and chuck assembly of a scriber for a brittle substrate capable of readily exchanging a wheel holder of a scriber used for scribing a substrate made of a brittle material.

Another object of the present invention is to provide a wheel holder and chuck assembly of a scriber for a brittle substrate requiring no modification of a center of the wheel holder depending on its exchange.

Still another object of the present invention is to provide a wheel holder and chuck assembly of a scriber for a brittle substrate capable of minimizing the number of components involved depending on replacement of a wheel holder and thus reducing maintenance cost.

According to an aspect of the present invention, there is provided a wheel holder and chuck assembly of a scriber for a brittle substrate including: a bearing mounted on a head of the scriber for scribing the substrate made of a brittle material; a wheel holder whose one end is connected to a holder shaft, and whose the other end has a wheel attached thereto; and a chuck whose one end is connected to the bearing, and whose the other end is detachably coupled to the holder shaft of the wheel holder.

The chuck may include: a shaft having a chuck shank fixed to the center of the bearing, and a chuck bolt having a hollow part at a center of the other end and a male threaded part formed at its outer periphery; a collet whose one end is inserted into the hollow part of the chuck bolt, and whose the other end accommodates the holder shaft inserted thereinto; and a clamping nut fixing the collet into the hollow part of the chuck bolt.

The shaft may have a male threaded part formed at an outer periphery of the other end having the hollow part so that the clamping nut is threadedly engaged with the threaded part. The shaft may be fixed to a center of the bearing.

The collet may include a plurality of collet fins disposed at predetermined angles and having the same size. A center of the collet and the center of the bearing may be collinear.

The holder shaft of the wheel holder may have a cylinder-shape.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a schematic view showing a structure of a conventional wheel holder assembly for a scriber;

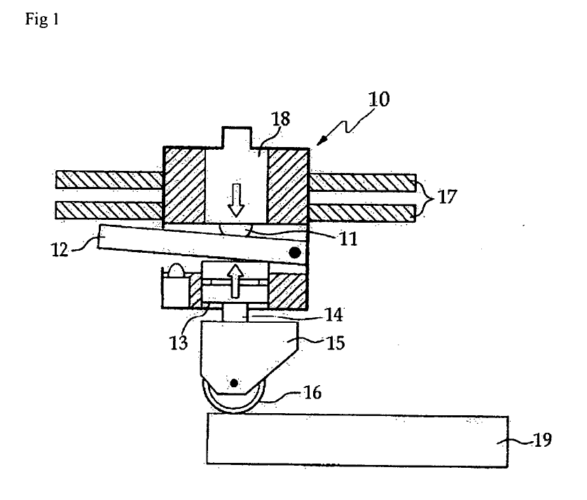

FIG. 2 is a schematic view showing a structure of another conventional wheel holder assembly for a scriber, which helps explaining about the conventional wheel holder assembly;

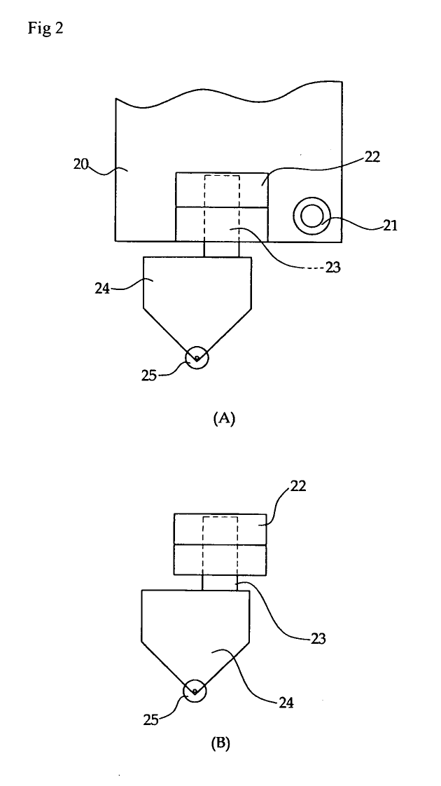

FIG. 3 is a schematic view showing a structure of a wheel holder and chuck assembly for a scriber according to the present invention; and

FIG. 4 is a perspective view showing the structure of the wheel holder and chuck assembly for a scriber according to the present invention.

### DETAILED DESCRIPTION OF THE INVENTION

Reference will now be made in detail to an exemplary embodiment of the present invention, an example of which is illustrated in the accompanying drawings.

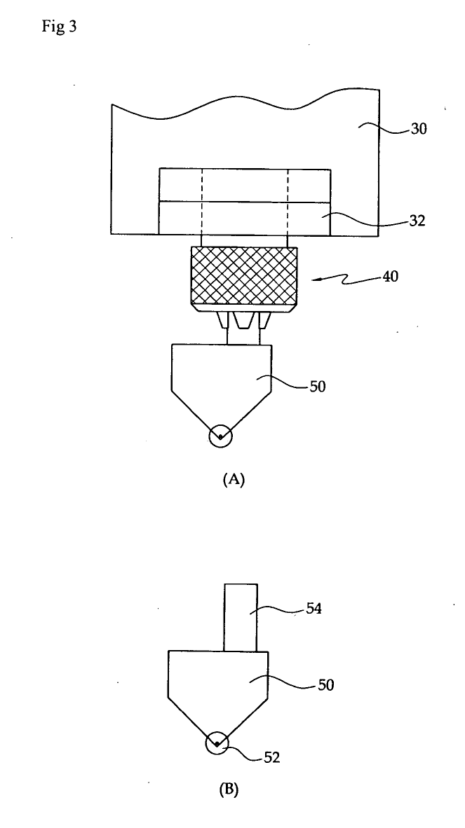

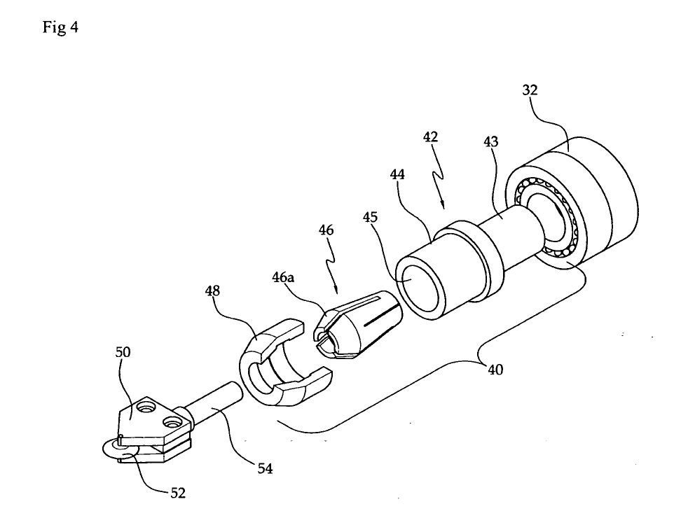

FIG. 3 is a schematic view showing a structure of a wheel holder and chuck assembly for a scriber according to the present invention, and FIG. 4 is a perspective view showing the structure of the wheel holder and chuck assembly for a scriber according to the present invention.

According to the present invention, the wheel holder and chuck assembly, as shown in FIGS. 3 and 4, includes a wheel holder 50 supporting a wheel 52 creating cracks on a substrate made of a brittle material, a head 30 mounting the wheel holder 50, and a chuck 40 mounting the wheel holder 50 to the head 30.

The head 30, which is an ordinary component of the scriber, includes means for moving the wheel 52 to a scribing position on the substrate.

The bearing 32 is attached to a lower part of the head 30. The chuck 40 is fixed to the center of the bearing 32. Unlike the conventional scriber, the outer periphery of the bearing 32 is securely fixed to the head 30.

The wheel 52, which forms a line of cracks on the substrate, is rotatably attached to one end of the wheel holder 50. A holder shaft 54, which is connected to the chuck 40, is formed on the other end of the wheel holder 50.

The holder shaft 54 is cylinder-shaped, and connected to the chuck 40.

The chuck 40 enables the wheel holder 50 to be readily attached to or detached from the head 30. The chuck 50, which may be a collet chuck as shown in FIG. 4, includes a shaft 42 having a chuck shank 43 formed at its one end and fixed to the center of the bearing 32, and a chuck bolt 44 having a hollow part 45 at a center of the other end and a male threaded part formed at an outer periphery thereof; a collet 46 whose one end is inserted into the hollow part 45 of the chuck bolt 44, and on which a holder shaft 54 of the wheel holder 50 is mounted; and a clamping nut 48 fixing the collet 46 into the hollow part 45 of the chuck bolt 44.

The collet 46 includes a plurality of collet fins 46a which serve to tighten the holder shaft 54 of the wheel holder 50 and precisely align the center of the collet 46 to the center of the holder shaft 54.

Two or more collet fins 46a, which are the same in size and shape, are formed to be inclined to the same degree with respect to a body of the collet 46. Three collet fins 46a, which cooperate with each other to position the holder shaft 54 at the center of the collet 46, may be formed.

The chuck 40 may be another conventional chuck enabling the holder shaft 54 to be attached to or detached from the head 30, even though different from that shown in FIG. 4.

Operation of the wheel holder and chuck assembly having the above-described configuration will now be described in detail.

First, the chuck shank 43 of the shaft 42 is fixed to the inside of the bearing 32 of the head 30. At this time, a rotation axis of the bearing 32 and a rotation axis of the shaft 42 have to be collinear.

The collet 46 is fixed into the hollow part 45 of the chuck bolt 44 formed at a lower part of the shaft 42.

After inserting the collet 46 into the hollow part 45 of the chuck bolt 44 as above described, the clamping nut 48 is screwed onto the chuck bolt 44 of the shaft 42.

The wheel holder 50 is attached to the head 30 by the following operations after the chuck 40 is assembled as above described. The collet fins 46a are untightened by unscrewing the clamping nut 48 from the chuck bolt 44. The holder shaft 54 of the wheel holder 50 is inserted into the inside of the collet 46 of the chuck 40. The holder shaft 54 is tightly fixed to the chuck 40 by screwing the clamping nut 48 onto the bolt 44, thereby enabling the collet fins 46a to tighten the holder shaft 54.

The wheel holder 50 is detached from the head 30 by the following operations when replacing the worn wheel 52. The collet fins 46a are untightened by unscrewing the clamping nut 48 from the chuck bolt 44. The wheel holder 50 is removed. After inserting a holder shaft 54 of a new wheel holder 50 into the collet 46, the clamping nut 48 is screwed onto the chuck bolt 44.

According to the present invention, when the wheel 52 is worn, it is possible to exchange only the wheel holder 50 without additional replacement of the bearing as in the conventional scriber, thus reducing maintenance cost.

As can be seen from the foregoing, a wheel holder is conveniently attached to and detached from a head of a scriber using a chuck, thus facilitating replacement of the wheel holder.

In addition, easy adjustment of the alignment between the center of the chuck and the center of the bearing of the head makes it possible to constantly maintain the scribing position of the wheel with respect to the substrate, regardless of the wheel holder replacement.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A wheel holder and chuck assembly of a scriber for scribing a substrate made of a brittle material, comprising:
a bearing mounted on a head of the scriber for scribing the substrate made of a brittle material;
a wheel holder whose one end is connected to a holder shaft, and whose the other end has a wheel attached thereto; and
a chuck whose one end is connected to the bearing, and whose the other end is detachably coupled to the holder shaft of the wheel holder.

2. The wheel holder and chuck assembly in accordance with claim 1, wherein the chuck comprises:
a shaft having a chuck shank fixed to the center of the bearing, and a chuck bolt having a hollow part at a center of the other end and a male threaded part formed at its outer periphery;
a collet whose one end is inserted into the hollow part of the chuck bolt, and whose the other end accommodates the holder shaft inserted thereinto; and
a clamping nut fixing the collet into the hollow part of the chuck bolt.

3. The wheel holder and chuck assembly in accordance with claim 2, wherein the chuck bolt of the shaft has a threaded part formed on its outer periphery so that the clamping nut is screwed onto and unscrewed from the chuck bolt.

4. The wheel holder and chuck assembly in accordance with claim 2, wherein the shaft is fixed to a center of the bearing.

5. The wheel holder and chuck assembly in accordance with claim 2, wherein the collet comprises two or more collet fins having the same size and shape and disposed at predetermined angles.

6. The wheel holder and chuck assembly in accordance with claim 2, wherein a center of the collet and a center of the bearing are collinear.

7. The wheel holder and chuck assembly in accordance with claim 1, wherein the holder shaft is cylinder-shaped.
